(19) United States
(12) Patent Application Publication
(10) Pub. No.: US 2014/0222481 A1
(43) Pub. Date: Aug. 7, 2014

(54) ELECTRONIC CALENDAR

(71) Applicant: David Kramf, Ganei Tikva (IL)

(72) Inventor: David Kramf, Ganei Tikva (IL)

(21) Appl. No.: 14/172,602

(22) Filed: Feb. 4, 2014

Related U.S. Application Data
(60) Provisional application No. 61/760,281, filed on Feb. 4, 2013.

(51) Int. Cl. G06Q 10/10

(52) U.S. Cl. CPC G06Q 10/1093
USPC 705/7.18

(57) ABSTRACT

The invention comprises a system and method for enabling a user to specify groups of dates using user-defined rules specified in plain English. These rules define lists of dates that are specified using a set of predefined atomic entities, Boolean logic, predicates, set operations such as union and intersection, and other rules. Using these methods, sets may be defined such as WorkingDays=Year—(Saturdays+Sundays+Holidays)

### FIELD OF THE INVENTION

The present invention relates to the field of calendars and scheduling.

### BACKGROUND OF THE INVENTION

A variety of systems exist that are adapted for scheduling events such as meetings and appointments, tasks, and the like. Such systems will generally allow for entry of event dates and times and possibly other information, reminders, locations, and the like. However the use of calendar information for further calculation is generally not possible, and hence a long-felt need remains for a system allowing such calculations to be made.

### SUMMARY OF THE INVENTION

The invention comprises a system and method for enabling a user to specify a set of rules generally concerning calendar dates in plain English. These rules define lists of objects that may be manipulated using a set of predefined rules, Boolean logic, and set operations such as union and intersection.

The foregoing embodiments of the invention have been described and illustrated in conjunction with systems and methods thereof, which are meant to be merely illustrative, and not limiting. Furthermore just as every particular reference may embody particular methods/systems, yet not require such, ultimately such teaching is meant for all expressions notwithstanding the use of particular embodiments.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The invention comprises a system for entering rules about dates in a simple plain-text format. These rules define groups of dates, and the rules can be combined to create more complex rules. The rules may use Boolean logic and may be modified using set operations such as union and intersection.

To be more specific, rules can be defined with the aid of atomic dates together with set operators (+/−), boolean constructors (and, or, not), predefined predicates (first, last week of, etc.) and other rules, to create more complex rules.

The basic element of the method is the rule. Every rule defines a list of dates. New rules can be created from existing rules using the arithmetic operators “+” “−” and “*”, these being set operations of union, difference, and intersection. Unique operators like “first”, “second”, “last”, “from”, “until”, and the like are also used. Atomic rules such the days of the week, months of the year, and the like are also available for use in rules.

Creating new rules from existing ones is done in plain English. For instance the new rule—“first sunday of july” is a combination of “first” “sunday” and “july” which are all predefined rules of calQuery.

The method determines rules from four sources. Basic predefined rules may be used, such as “year” which denotes all days of the current year or “Sundays” which denotes all the Sundays of the year. These are predefined and available for immediate use.

Further rules are created from the calendars found in the user's calendar database(s). For each calendar a rule is created with the name of the calendar, which denotes all days which have an event in that calendar. Both local and subscribed rules are interrogated.

After that the method uses rules defined by the user, for example in a human-readable text file of rules such as “rules.txt”. Users can add their unique and commonly used rule, either by direct editing of this file or through use of a special GUI constructed for this purpose.

Rules may also be entered in the command line in some embodiments of the invention. In other possible embodiments, rules may be entered into interfaces or widgets called by various calendar or organizational programs.

It is within provision of the invention that a “find” functionality be implemented, which is used to define queries regarding intervals. For instance “find 2 hours in next week” will scan your calendar and identify days where you have 2 free hours between 08:00 to 18:00.

### Basic Rules

The most basic rule is the rule which denotes a single date. This rule name is composed from the month (which may be abbreviated by its first three letters) together with the date. For instance the date 17 of October may be referred to as oct17. Dates refer to the current year unless otherwise specified.

So if we have a family with 3 members we can define the birthday rule using the set ‘union’ operator as follows:

### FamilyBirthdays=Mar17+Dec22+Jan29.

The name of this rule is “FamilyBirthdays” and it denotes 3 dates.

Specific elements of the sets of dates defined by rules may also be accessed. For example, “first”, “second” etc., “last” and “Nth” may all be used to access particular dates of a set. Thus in the example above, the rule

### FirstBirthday=First of FamilyBirthdays,

defines a list containing one date, namelu jan29. Similarly, “last of FamilyBirthdays” will generate the single date dec22.

### Set Operators

Suppose the “family” rule contains all dates of a large family and the user wants to know if there are any family events in July. There is provision in the invention for determining such groups of dates. For this case, one can use the intersection operator “*” to find the family events occurring in July as follows:

### JulyEvents=FamilyBirthdays*July

Now JulyEvents contains the (possibly empty) list of family birthdays in July. As should be clear from the example, the “*” (set intersection) symbol gives the list of dates which exist on both of the lists the operator joins.

The mathematical operators (“+” “−” “*”) and parentheses follow the usual precedence rules known from arithmetic. Thus the rule “june+july*FamilyBirthdays” will result in a list containing all days of June together with days of July which happen to be family birthdays. If you wish to inquire what family birthdays occur in June and July one can use the rule

### (June+July)*Family

The symbol “−” between two sets result in the difference, namely the dates that exists in the left hand set and do not exist in the right one. Suppose one employs the rule “holiday” which contains all your holidays dates and you want to get the list of your working days. One can just use the rule

### WorkDays=Year—Saturdays—Sundays—Holidays

to define the working days of the year.

### Further Operators

In addition to the arithmetic symbols, the inventive method offers several unique operators that operates on a list and picks a date or list of dates out of the operands. We have already mentioned “first” and “last”, which are used to 110 operate on a list. Thus one can enter “first day of july” to get the very first day of July, for example, or “first week of december” or “last month of the year”. These latter use the “week” and “year” lists which are built into the system by default. One can also use rules to serve as descriptors. For instance “first workDays of april” will give the first working day in the month of April.

Two other important operators are the “before” and “after” operators. In addition to the descriptor we defined in the last section, these two operators use a second numeric operand, which may be specified in English or using numerals. Thus for instance “three days before july” or “eight workingDays after jun15” are all valid rules.

In addition to the operations mentioned above, the system can be instructed to look for free time in a list of dates, using the “find” operator. For example, “find 2 hours next sunday” will look for free time windows in one's next Sunday schedule, whose length is at least 2 hours. The command “find 2 hours in workingDays*july” will return all free time periods in one's July workingDays. By default the period searched for is between 08:00 to 18:00 but this can be controlled using the operator “between” to refine the search—“between 16:00 to 18:00” or “between 04:00 to 22:00” or “between 02:00 AM to 08:00 PM” are all valid. As should be clear from the above examples, one can also use “after ” and “before” as further operands after the “find” in order to refine the search results.

In addition to “hour” you can use “minutes”, for example “find 27 minutes next sunday”.

### Atomic Entities

The following dates and ranges are known to the system before being given extra rules:

As a further example, the rule

### NewYearsDay=First Day Of Year

defines NewYearsDay as the first day of the year, which is an entity the system recognizes (The system recognizes the Nth day of the year automatically). The rule

### IndependenceDay=4July

simply defines an entitity IndependenceDay having as its value the particular date 4July

### Likewise the Rule

### MemorialDay=Last Monday Of May

creates an object MemorialDay which is the single date that is the last Monday in the month of May. As the qualifier ‘last’ and the entities ‘Monday’ and ‘May’ are already recognized by the system, the new object MemorialDay can be found for any given year.

More complicated rules can be used as well. The definition

### VeteransDay=Monday Of Second Week Of Nov

uses the qualifier ‘second’ which is also built into the system to define when Veterans Day occurs, namely the Monday of the second week of November.

As mentioned, sets may be combined using set operators such as union (symbolized by the “+” sign) and intersection (the “*” sign). Thus the definition

### Holidays=NewYearDay+MemorialDay+IndependanceDay+VeteransDay

allows for New Years, Memorial Day, Independence Day, and Veterans Day to be combined into the single set named Holidays.

Similarly, the ‘intersection’ operator, symbolized by “−”, may be used to remove parts of a set, for instance:

### WorkingDays=Year—(Saturdays+Sundays+Holidays)

Allows for Saturdays, Sundays, and Holidays to be removed from all the year's days and thereby to arrive at only the working days of a year.

As an example of a simple rule being followed by progressively more complicated rules building on it, consider the following:

### WeddingDay=25Oct

Defines a simple single date for WeddingDay. The reminder

### WeddingRemindar=Sunday Of Week Of WeddingDay

Allows for a reminder that depends on the date of WeddingDay. Now an object ‘PossibleImportantBusinessMeetingDates’ can be defined in terms of WeddingDay and the previously defined WorkingDays:

### PossiblelmportantBusinessMeetingDates=Week after WeddingDay*WorkingDays

A user can list all dates defined by a certain rule or use them in a variety of ways. For example, the user can create events for dates defined, send emails on dates defined, set reminders, activate scripts, turn on/off net connected devices, and in short perform any action that can be mediated by computerized means.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

1. A method for specifying a set of dates using English-language rules defined in terms of atomic entities, set operators, predefined predicates, other sets of dates, and a “find” operator, wherein said sets may be combined with one another to arrive at arbitrarily complex set definitions.

2. The method of claim 1 wherein said atomic entities comprise the months of the year, the days of the week, the days of the year, individual dates, years.

3. The method of claim 1 wherein said predefined predicates are selected from the group consisting of: first, second, Nth, last, before, after, between, during, from, until.

4. The method of claim 1 wherein said set operators are selected from the group consisting of: union, intersection, difference.

5. The method of claim 1 wherein said “find” operator operates on two arguments, these being a duration and a set of dates, and returns the unoccupied times equal to or longer than said duration, found on said set of dates.
